(19) United States
(12) Patent Application Publication
(10) Pub. No.: US 2024/0131732 A1
(43) Pub. Date: Apr. 25, 2024

(54) ARM-SHAPED STRUCTURE AND ROBOT

(71) Applicant: FANUC CORPORATION, Yamanashi (JP)

(72) Inventor: Kazutaka NAKAYAMA, Yamanashi (JP)

(73) Assignee: FANUC CORPORATION, Yamanashi (JP)

(21) Appl. No.: 18/546,621

(22) PCT Filed: Mar. 24, 2022
(86) PCT No.: PCT/JP2022/014209

§ 371 Date: Aug. 15, 2023

(30) Foreign Application Priority Data
Mar. 30, 2021 (JP) 2021-058981

(51) Int. Cl. B25J 18/00

(52) U.S. Cl. CPC B25J 18/00

(57) ABSTRACT

An arm-shaped structure includes a pipe-shaped main body and a metallic attachment interface joined to at least one end of the main body and securable to another component. At least a portion of the main body and the attachment interface is formed by casting. The main body and the attachment interface are joined to each other in a state where relative movement along a longitudinal axis of the main body and around the longitudinal axis is prevented in accordance with engagement between a recess provided in one of the main body and the attachment interface and a protrusion provided in the other one of the main body and the attachment interface.

### TECHNICAL FIELD

The present disclosure relates to arm-shaped structures and robots.

### BACKGROUND

In order to ensure enough strength while achieving weight reduction, an arm of an industrial robot is normally formed by casting metal, such as an aluminum alloy (e.g., see Japanese Unexamined Patent Application, Publication No. 2013-018058).

### SUMMARY

An aspect of the present disclosure provides an arm-shaped structure including a pipe-shaped main body and a metallic attachment interface joined to at least one end of the main body and securable to another component. At least a portion of the main body and the attachment interface is formed by casting. The main body and the attachment interface are joined to each other in a state where relative movement along a longitudinal axis of the main body and around the longitudinal axis is prevented in accordance with engagement between a recess provided in one of the main body and the attachment interface and a protrusion provided in the other one of the main body and the attachment interface.

### BRIEF DESCRIPTION OF DRAWINGS

FIG. 1 is a front view illustrating an arm-shaped structure according to an embodiment of the present disclosure.

FIG. 2 is a vertical sectional view illustrating the arm-shaped structure in FIG. 1.

FIG. 3 is a partially-enlarged vertical sectional view illustrating an attachment interface of the arm-shaped structure in FIG. 1.

FIG. 4 is a vertical sectional view illustrating an example of a mold used for manufacturing the arm-shaped structure in FIG. 1.

FIG. 5 is a partial vertical sectional view of the attachment interface and illustrates a first modification of the arm-shaped structure in FIG. 1.

FIG. 6 is a partial vertical sectional view of the attachment interface and illustrates a second modification of the arm-shaped structure in FIG. 1.

FIG. 7 is a partial vertical sectional view of the attachment interface and illustrates a third modification of the arm-shaped structure in FIG. 1.

FIG. 8 is a partial vertical sectional view of the attachment interface and illustrates a fourth modification of the arm-shaped structure in FIG. 1.

FIG. 9 is a partial vertical sectional view of the attachment interface and illustrates a fifth modification of the arm-shaped structure in FIG. 1.

### DETAILED DESCRIPTION OF EMBODIMENTS

An arm-shaped structure 1 and a robot according to an embodiment of the present disclosure will be described below with reference to the drawings.

The arm-shaped structure 1 according to this embodiment is, for example, a robot arm.

The robot according to this embodiment includes at least one arm-shaped structure 1.

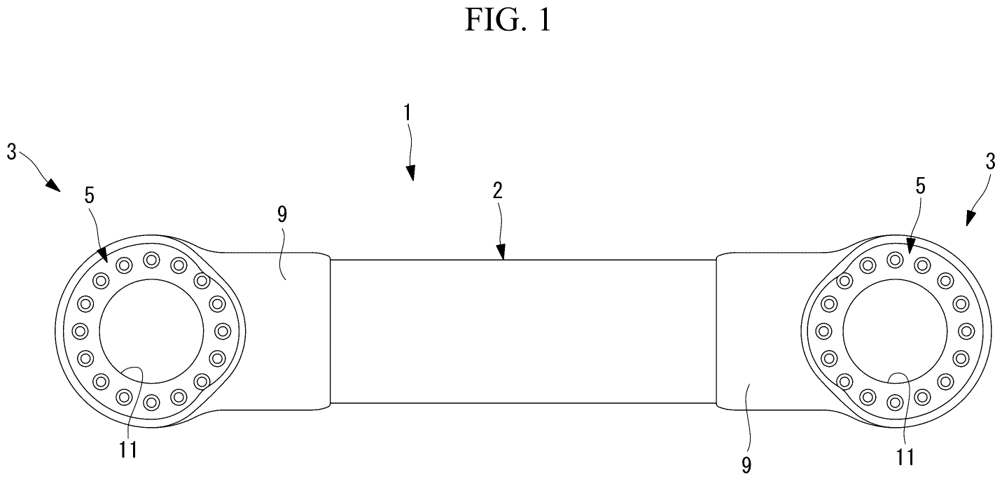

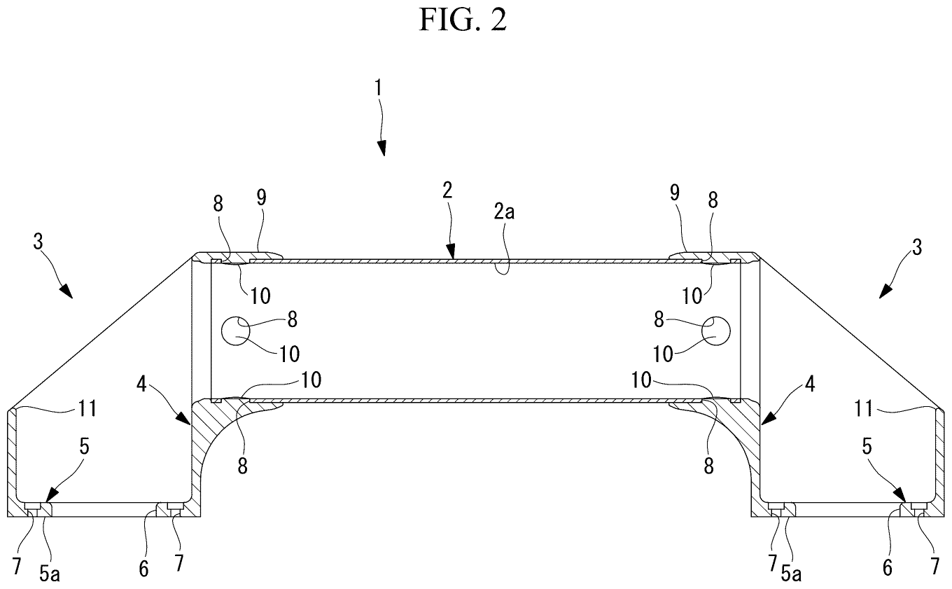

As shown in FIGS. 1 and 2, the arm-shaped structure 1 according to this embodiment includes a cylindrical-pipe-shaped main body 2 having an inner hole 2a, and also includes a pair of attachment interfaces 3 joined to opposite longitudinal ends of the main body 2.

For example, the main body 2 is formed of a pipe composed of metal, such as an aluminum alloy, and has an inner hole extending therethrough in the longitudinal direction.

The attachment interfaces 3 are formed by casting metal, such as an aluminum alloy, and each have a hollow section 4 communicating with the inner hole 2a of the main body 2. The metal used for forming the main body 2 and the attachment interfaces 3 may alternatively be a magnesium alloy and the like. The attachment interfaces 3 may be composed of a magnesium alloy, and the main body 2 may be composed of an aluminum alloy. Furthermore, the metal used may be iron in a thin-walled form.

Each attachment interface 3 is provided with a ring-shaped flange 5 for securing each attachment interface 3 to another component constituting the robot, for example, an output shaft of a speed reducer. The flanges 5 of the pair of attachment interfaces 3 respectively have flanged surfaces 5a disposed in the same plane that is parallel to a longitudinal axis of the main body 2.

Each flange 5 has a center hole 6 that exposes the hollow section 4 in the center, and also has a plurality of through-holes 7 arranged with a distance therebetween in the circumferential direction around the center hole 6. A wire body, such as a cable, extends through the inner hole 2a of the main body 2 via the center hole 6 in one of the flanges 5, and can be routed from the center hole 6 in the other flange 5 along an extraction path. Each flange 5 is provided within the corresponding hollow section 4 for improving the external appearance of the arm, and has an opening 11 with a relatively large size to allow insertion of a tool or a human hand.

The main body 2 and the pair of attachment interfaces 3 are joined together in accordance with the following structure.

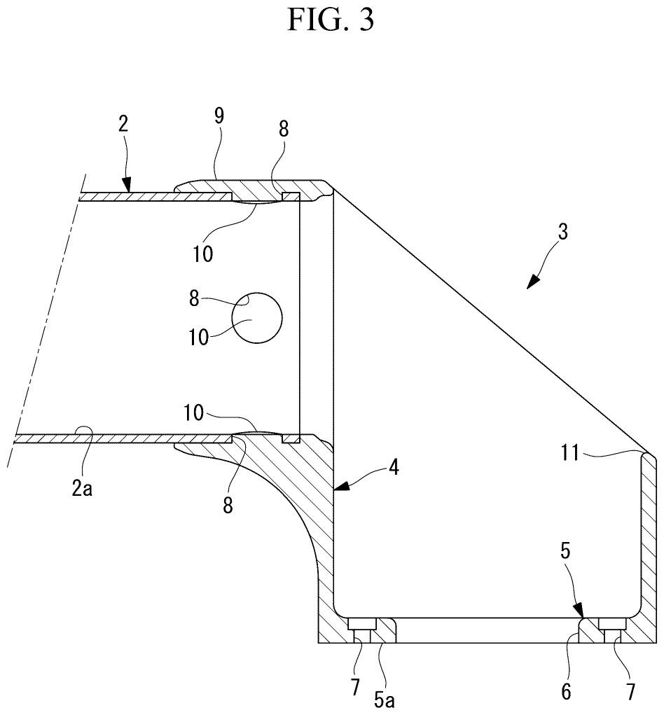

Specifically, as shown in FIGS. 2 and 3, the main body 2 has through-holes (recesses) 8 extending therethrough in a radial direction (i.e., in a direction orthogonal to the longitudinal axis) at positions located away from the opposite longitudinal ends by a predetermined distance. The through-holes 8 are circular in cross section. A plurality of, for example, four, through-holes 8 arranged with a distance therebetween in the circumferential direction is provided in the vicinity of each end. The orientation of the through-holes 8 is not limited to the radial direction (i.e., the direction orthogonal to the longitudinal axis), and may extend in a direction intersecting the longitudinal direction.

The attachment interfaces 3 are provided with cylindrical engagement sections 9 and protrusions 10. Each engagement section 9 engages with the outer peripheral surface at each of the opposite ends of the main body 2. The protrusions 10 protrude radially inward from the inner surface of each engagement section 9 and have a complementary shape with the through-holes 8 in the main body 2 to tightly engage therewith.

A manufacturing method of the arm-shaped structure 1 according to this embodiment having the above-described configuration will be described below.

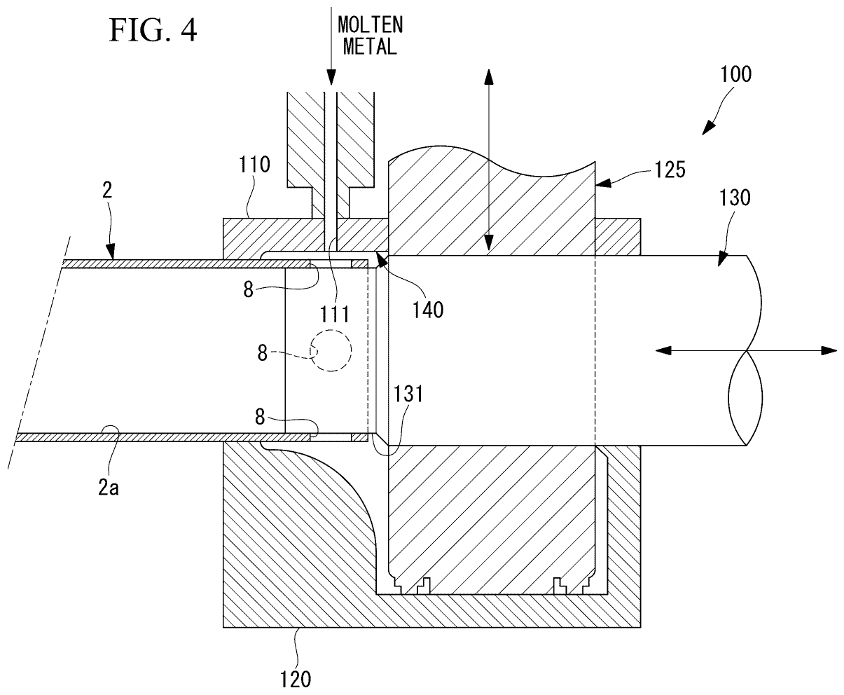

For example, the arm-shaped structure 1 according to this embodiment is manufacturing by casting using a mold 100, such as an aluminum-die-casting mold shown in FIG. 4.

The mold 100 includes an upper mold 110 and a lower mold 120 that are openable and closable in the up-down direction, a cylindrical first movable mold 125 supported in such a manner as to be rectilinearly movable in the vertical direction, and a cylindrical second movable mold 130 extending through the first movable mold 125 and supported in such a manner as to be rectilinearly movable in the horizontal direction. The distal end of the second movable mold 130 is provided with an engagement protrusion 131 engageable with the inner hole 2a of the main body 2 without any gaps therebetween.

The manufacturing method according to this embodiment first involves forming the through-holes 8 in the vicinity of the opposite ends of the main body 2.

Then, as shown in FIG. 4, one end of the main body 2 is inserted from one side in the horizontal direction into a space formed as a result of closing the upper mold 110 and the lower mold 120, so that the one end of the main body 2 is accommodated within the space. The first movable mold 125 is inserted from above, and the second movable mold 130 is inserted horizontally from a direction opposite to the main body 2, whereby the engagement protrusion 131 is engaged with the inner hole 2a in the main body 2.

Accordingly, a cavity 140 corresponding to the attachment interface 3 is formed by the upper mold 110, the lower mold 120, the first movable mold 125, the second movable mold 130, and the outer surface of the main body 2. Then, molten metal is injected into the cavity 140 via a through-hole 111 provided in the upper mold 110, so that the attachment interface 3 can be formed at the one end of the main body 2 by casting.

Specifically, the attachment interface 3 is casted by using the main body 2 as an insert component, whereby the arm-shaped structure 1 is manufactured.

The position of the through-hole 111 is not limited to the position shown in FIG. 4. An optimal position may be set in view of the fluidity of the metal within the cavity 140.

As the molten metal is injected into the cavity 140 in the casting process of the attachment interface 3, the cylindrical engagement section 9 surrounding the one end of the main body 2 over a longitudinal range including the through-holes 8 is formed at a position where the engagement section 9 is in close contact with the outer peripheral surface of the main body 2. A portion of the molten metal of the engagement section 9 flows into the through-holes 8 and extends radially inward from the inner surface of the engagement section 9, whereby the cylindrical protrusions 10 having a complementary shape with the through-holes 8 are formed.

Specifically, in the arm-shaped structure 1 according to this embodiment, the protrusions 10 formed during the injection process of the molten metal are engaged with the through-holes 8 formed in the main body 2. Accordingly, the pair of attachment interfaces 3 joined to the opposite ends of the main body 2 can be secured to the main body 2 in a state where relative movement is regulated in the axial direction and the circumferential direction of the main body 2, that is, in a state where relative movement along the longitudinal axis of the main body 2 and around the longitudinal axis is prevented.

Specifically, the main body 2 and each attachment interface are joined to each other in a state where relative movement along the longitudinal axis of the main body 2 and around the longitudinal axis is prevented by engaging the protrusions 10, which are formed when the attachment interface 3 is formed by casting, with the through-holes (recesses) 8 in the main body 2.

Since the main body 2 and the attachment interfaces 3 are not integrally casted, deterioration in fluidity is prevented even if the main body 2 is reduced in wall thickness, whereby a reduced yield rate can be advantageously prevented. Moreover, with the use of a thin-walled pipe as the main body 2, weight reduction can be effectively achieved.

In terms of strength, it is better for the pipe-shaped main body 2 to be thin-walled and the attachment interfaces 3 at the opposite ends to be thick-walled rather than the main body 2 to be thick-walled and the attachment interfaces 3 to be thin-walled. Therefore, a cut thin-walled pipe is used as the main body 2, and the attachment interfaces 3 are casted at the opposite ends thereof, so that a well-balanced, lightweight metallic arm can be manufactured.

As an alternative to this embodiment in which the through-holes 8 provided in the main body 2 are circular in cross section, the through-holes 8 may have an arbitrary cross-sectional shape. Moreover, the size of the cross-sectional shape may be arbitrary. The through-holes 8 and the protrusions 10 preferably have a non-angular shape to avoid stress concentration.

The number of through-holes 8 provided in the main body 2 may be one or more. It is desirable that the number of through-holes 8 be set such that the main body 2 has enough strength to prevent the engagement sections 9 from falling out or rotating as a result of shear-fracturing of the protrusions 10 or the through-holes 8 serving as recesses. In order to ensure high strength, multiple through-holes 8 may be disposed evenly around the main body 2.

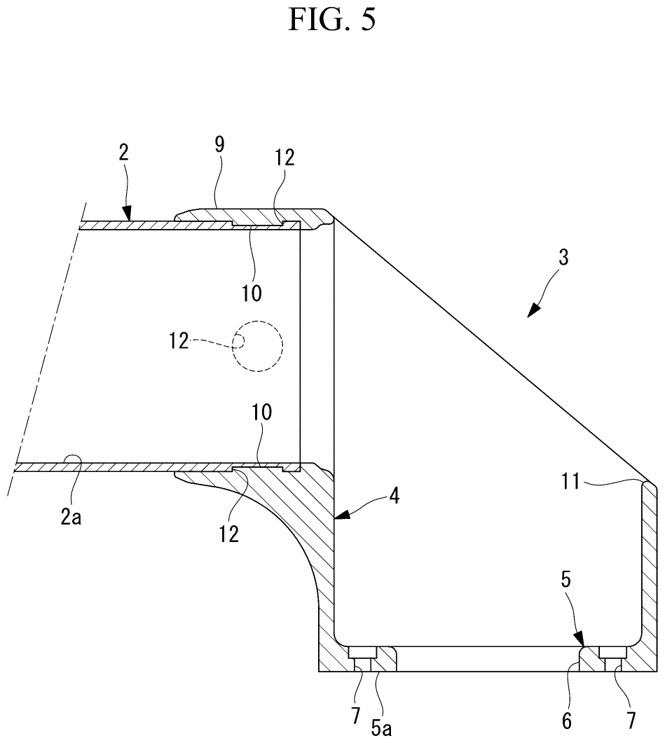

Although the recesses provided in the main body 2 are the through-holes 8 in this embodiment, the configuration is not limited to this. As shown in FIG. 5, recesses 12 extending radially inward from the outer peripheral surface of the main body 2 but not extending therethrough may be employed. With this configuration, the through-holes 8 do not need to be blocked by the second movable mold 130, thereby further simplifying the structure of the mold 100.

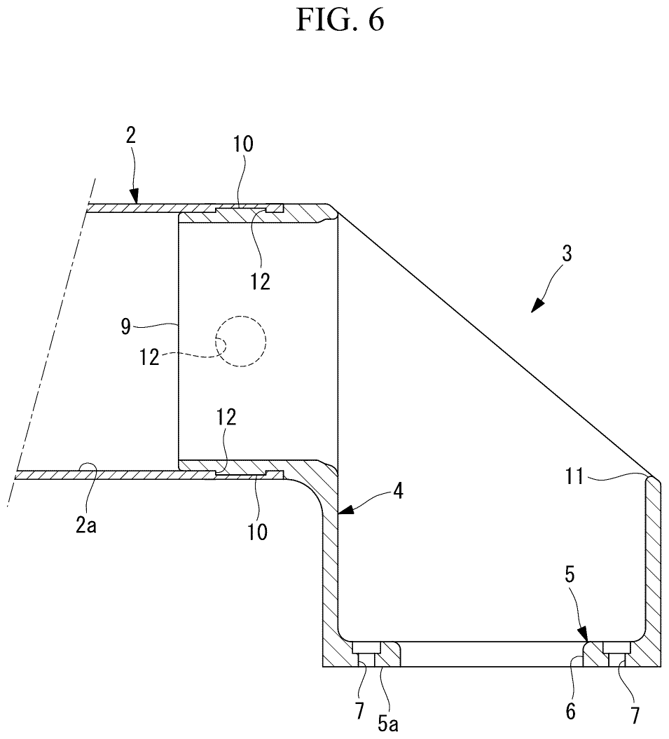

The recesses 12 may be recessed radially inward from the outer peripheral surface of the main body 2 or may be recessed radially outward from the inner peripheral surface of the main body 2. If the recesses 12 are provided in the inner peripheral surface, the engagement section 9 of each attachment interface 3 may be cylindrical to engage with the inner peripheral surface of the main body 2, as shown in FIG. 6.

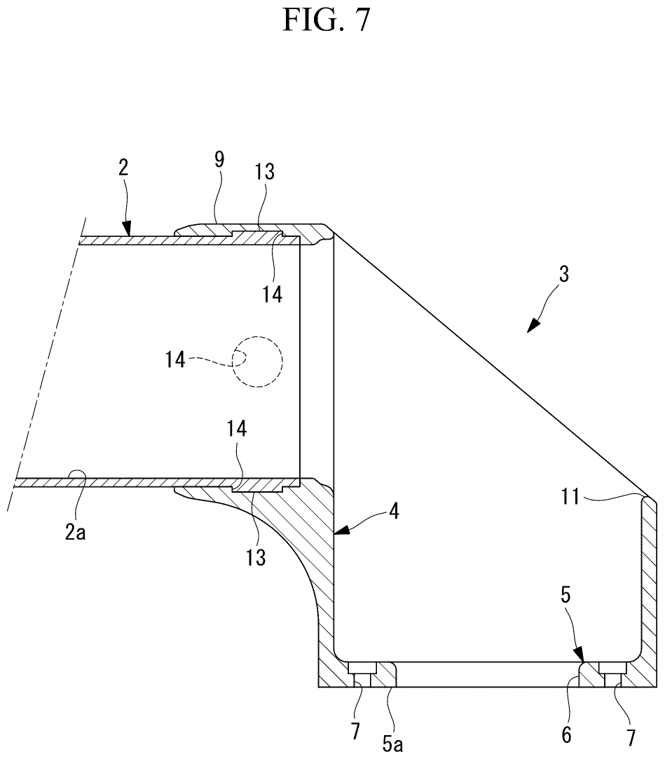

Furthermore, as shown in FIG. 7, the recesses 12 may be replaced by protrusions 13 extending radially from the outer peripheral surface or the inner peripheral surface of the main body 2. In this case, as shown in FIG. 7, each attachment interface 3 has recesses 14 that have a complementary shape with the protrusions 13 and that accommodate the protrusions 13.

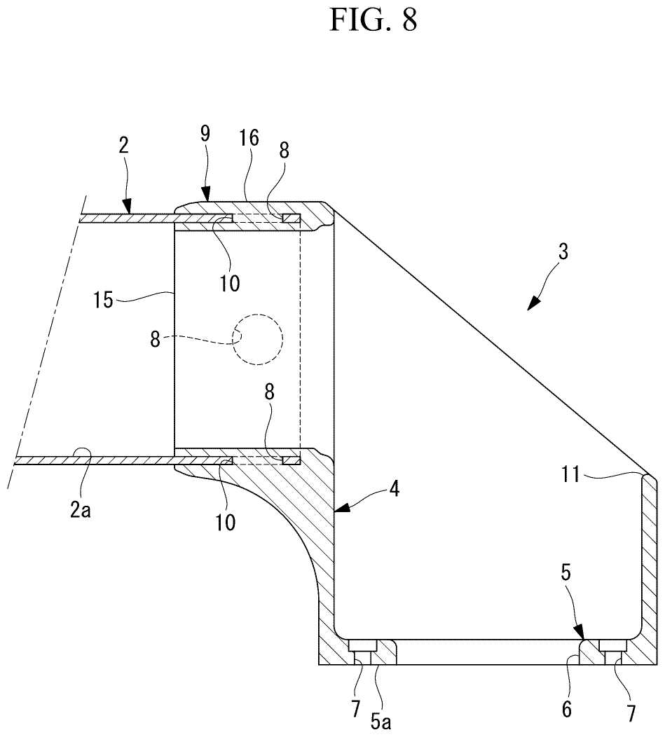

Furthermore, as shown in FIG. 8, the engagement section 9 of each attachment interface 3 may have both an inner engagement section 15 that engages with the inner peripheral surface of the main body 2 and an outer engagement section 16 that engages with the outer peripheral surface of the main body 2. In this case, the protrusions 10 formed within the through-holes 8 of the main body 2 have a columnar shape to couple the inner engagement section 15 and the outer engagement section 16 to each other. Accordingly, the attachment interface 3 and the main body 2 can be joined to each other more securely.

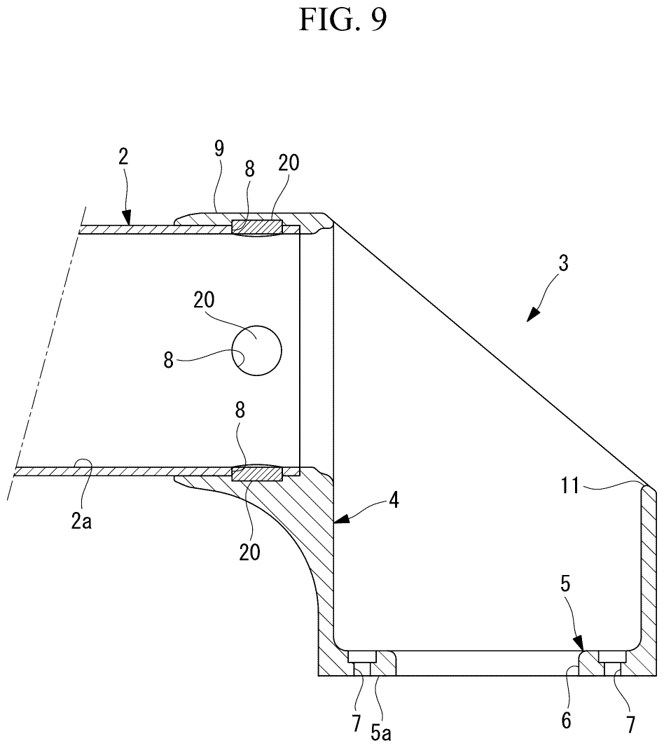

Furthermore, as shown in FIG. 9, another member different from the main body 2 or the attachment interface 3 may be set as an insert in the mold together with the main body 2, and the attachment interface 3 may be subsequently casted.

As an alternative to a metallic pipe, the main body 2 may be formed of an arbitrary material so long as the main body 2 can be used as an insert component during the casting process of each attachment interface 3.

As an alternative to this embodiment in which the arm-shaped structure 1 has the attachment interfaces 3 at the opposite ends of the main body 2, only one end thereof may have the attachment interface 3. As an alternative to the above example where the flanges 5 are provided parallel to the longitudinal axis of the arm-shaped structure 1, the flanges 5 may extend in a direction intersecting the longitudinal axis of the arm-shaped structure 1.

As an alternative to the above example where a robot arm is described as the arm-shaped structure 1, it may be applied to another arbitrary arm-shaped structure.

The main body 2 is not limited to having the shape of a straight round pipe, and may have a shape that increases in diameter toward the opposite ends thereof, or may have the shape of a square pipe.

Although the example in FIG. 4 relates to the use of an aluminum-die-casting mold, sand-casting may be employed instead of using the mold 100.

Although the embodiment of the present invention has been described above, it is clear to a skilled person that various alterations and modifications are achievable so long as they do not depart from the scope disclosed in the claims to be described below. An appropriate combination of some features of the above-described embodiment or an embodiment according to a non-described manufacturing method are also included in the scope of the present disclosure.

1. An arm-shaped structure, comprising:
a pipe-shaped main body; and
a metallic attachment interface joined to at least one end of the main body and securable to another component,
wherein at least a portion of the main body and the attachment interface is formed by casting, and
wherein the main body and the attachment interface are joined to each other in a state where relative movement along a longitudinal axis of the main body and around the longitudinal axis is prevented in accordance with engagement between a recess provided in one of the main body and the attachment interface and a protrusion provided in the other one of the main body and the attachment interface.

2. The arm-shaped structure according to claim 1,
wherein the main body is composed of metal.

3. The arm-shaped structure according to claim 1,
wherein the attachment interface is cast by using the main body as an insert component.

4. A robot comprising at least one arm-shaped structure according to claim 1.
